(19) United States
(12) Patent Application Publication
(10) Pub. No.: US 2026/0153831 A1
(43) Pub. Date: Jun. 4, 2026

(54) CONTROL DEVICE, IMAGE FORMING APPARATUS, WASTE TONER CONVEYANCE UNIT, AND STORAGE MEDIUM

(71) Applicant: Konica Minolta, Inc., Tokyo (JP)

(72) Inventors: Yutaka MIZOTA, Toyokawa-shi (JP); Yuji OKUGAWA, Toyokawa-shi (JP)

(21) Appl. No.: 19/399,803

(22) Filed: Nov. 25, 2025

(30) Foreign Application Priority Data
Dec. 2, 2024 (JP) 2024-209251

(51) Int. Cl. G03G 21/10; G03G 15/00; G03G 15/08

(52) U.S. Cl. CPC G03G 21/105; G03G 15/0808; G03G 15/0891; G03G 15/50

(57) ABSTRACT

A control device includes, a first member; a second member that is configured to be capable of switching between an engaged state in which the second member is engaged with the first member and a disengaged state in which the second member is not engaged with the first member; and a hardware processor that executes, a first operation in which the first member in the engaged state is rotated in a first direction, and a second operation in which the first member is rotated in a second direction opposite to the first direction to alternately switch between the engaged state and the disengaged state, and when switching from the disengaged state to the engaged state, the first member is moved in a direction that is parallel to a rotation axis of the first member to be engaged with the second member, thereby vibrating the second member.

### CROSS-REFERENCE TO RELATED APPLICATION

The present invention claims priority under 35 U.S.C. § 119 Japanese Patent Application No. 2024-209251, filed on Dec. 2, 2024, the entire content of which is incorporated herein by reference.

### BACKGROUND OF THE INVENTION

### Technical Field

The present disclosure relates to a control device, an image forming apparatus, a waste toner conveyance unit, and a storage medium.

### Description of Related Art

An image forming apparatus using an electrophotographic process technique charges, with a charging device, a surface of a photosensitive drum serving as a latent image bearing member. Next, the image forming apparatus forms an electrostatic latent image on the surface of the photosensitive drum by emitting laser light based on the image data. Next, the image forming apparatus visualizes the electrostatic latent image by supplying a developer to the photosensitive drum from a developing device, to form a toner image on the photosensitive drum. Next, the image forming apparatus transfers and fixes the toner image onto a sheet, to form an image on the sheet.

In such image forming apparatus, there is a problem that toner adhered and accumulated on the developing device drops at the time of image formation and adheres to the photosensitive drum or is transferred onto a transfer belt, thus causing image defect such as image contamination.

In response to such problem, the image forming apparatus includes an excitation means for performing an excitation operation to apply vibration to the developing device in order to restrain toner from accumulating on the developing device.

In relation to this, Japanese Unexamined Patent Publication No. 2007-334214 discloses an image forming apparatus which includes the excitation means for applying vibration to a waste toner collection case to suppress accumulation of the toner in the waste toner collection case.

The excitation means includes a first member and a second member that can be brought into an engaged state and a disengaged state. The first member is in an engaged state with the second member and rotates in a first direction together with the second member in a printing operation in which a developing process is performed. On the other hand, the first member rotates in a direction opposite to the first direction with respect to the stopped second member in an excitation operation. Thus, vibration is transmitted from the first member to the second member when the first member and the second member are switched from the disengaged state to the engaged state.

In the image forming apparatus, when a printing operation is executed in a case where the first member and the second member are in a disengaged state after the excitation operation, the first member rotates in the first direction at a high speed and engages with the second member, so that a large impact force is generated at an engagement location. Thus, there is a problem in that wear occurs at the engagement location.

### SUMMARY OF THE INVENTION

An object of the present disclosure is to provide a control device, an image forming apparatus, a waste toner conveyance unit, and a storage medium that can reduce wear at an engagement location between members.

According to an aspect of the present disclosure, a control device reflecting one aspect of the present disclosure includes,
a first member;
a second member that is configured to be capable of switching between an engaged state in which the second member is engaged with the first member and a disengaged state in which the second member is not engaged with the first member; and
a hardware processor that executes, a first operation in which the first member in the engaged state is rotated in a first direction, and a second operation in which the first member is rotated in a second direction opposite to the first direction to alternately switch between the engaged state and the disengaged state, and when switching from the disengaged state to the engaged state, the first member is moved in a direction that is parallel to a rotation axis of the first member to be engaged with the second member, thereby vibrating the second member,
wherein the hardware processor performs, after the second operation, a third operation of rotating the first member in the first direction at a rotational speed slower than the rotational speed during the first operation, and the first member and the second member are engaged to the engaged state.

According to another aspect of the present disclosure, an image forming apparatus reflecting one aspect of the present disclosure includes,
the control device described above,
wherein the image forming apparatus forms an image on a sheet.

According to another aspect of the present disclosure, a waste toner conveyance unit reflecting one aspect of the present disclosure includes,
the control device described above;
a waste toner conveyance route that conveys waste toner;
a waste toner conveyor disposed in the waste toner conveyance route; and
a driver that drives the first member,
wherein the first member,
   in the first operation, transmits a driving force from the driver to the waste toner conveyor via the second member in the engaged state with the first member, and
   in the second operation, applies vibration to the waste toner conveyor and the waste toner conveyance route via the second member.

According to another aspect of the present disclosure, a storage medium reflecting one aspect of the present disclosure is a non-transitory computer readable storage medium including a program executed in a computer provided with a control apparatus including, a first member; and a second member that is configured to be capable of switching between an engaged state in which the second member is engaged with the first member and a disengaged state in which the second member is not engaged with the first member, to function as a controller that executes,
a first operation in which the first member in the engaged state is rotated in a first direction, and a second operation in which the first member is rotated in a second direction opposite to the first direction to alternately switch between the engaged state and the disengaged state, and when switching from the disengaged state to the engaged state, the first member is moved in a direction that is parallel to a rotation axis of the first member to be engaged with the second member, thereby vibrating the second member,
wherein the controller performs, after the second operation, a third operation of rotating the first member in the first direction at a rotational speed slower than the rotational speed during the first operation, and the first member and the second member are engaged to the engaged state.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present disclosure, and wherein:

FIG. 1 is a diagram illustrating a schematic configuration of an image forming apparatus according to a first embodiment;

FIG. 2 is a block diagram illustrating a functional configuration of the image forming apparatus according to the first embodiment;

FIG. 3 is a schematic cross-sectional view in a YZ plane in vicinity of a developing device according to the first embodiment;

FIG. 4 is a schematic diagram illustrating the vicinity of the developing device according to the first embodiment when viewed from above;

FIG. 5 is a schematic side view of the vicinity of the developing device according to the first embodiment;

FIG. 6A, FIG. 6B, and FIG. 6C are schematic diagrams illustrating a portion of a drive mechanism when a drive transmission member rotates in a first direction;

FIG. 7 is a schematic diagram of a drive transmission member;

FIG. 8A, FIG. 8B, and FIG. 8C are schematic diagrams illustrating a portion of the drive mechanism when the drive transmission member rotates in a second direction;

FIG. 9A, FIG. 9B, and FIG. 9C are schematic diagrams illustrating a portion of the drive mechanism when the drive transmission member rotates in the second direction;

FIG. 10A, FIG. 10B, and FIG. 10C are schematic diagrams illustrating a portion of the drive mechanism when the drive transmission member rotates in the second direction;

FIG. 11A, FIG. 11B, and FIG. 11C are schematic diagrams illustrating a portion of the drive mechanism when the drive transmission member rotates in the second direction;

FIG. 12A, FIG. 12B, and FIG. 12C are schematic diagrams illustrating a portion of the drive mechanism when the drive transmission member rotates in the second direction;

FIG. 13A, FIG. 13B, and FIG. 13C are schematic diagrams illustrating a portion of the drive mechanism when the drive transmission member rotates in the second direction;

FIG. 14 is a schematic diagram illustrating a configuration of an image forming section according to a third embodiment;

FIG. 15 is a schematic diagram illustrating the configuration of the image forming section according to the third embodiment; and

FIG. 16 is a schematic diagram illustrating the configuration of the image forming section according to the third embodiment.

### DETAILED DESCRIPTION

Hereinafter, one or more embodiments of the present disclosure will be described with reference to the drawings. However, the scope of the invention is not limited to the disclosed embodiments.

Hereinafter, the present embodiment will be described in detail with reference to the drawings. However, the scope of the invention is not limited to the illustrated examples.

### First Embodiment

### 1. Configuration of Image Forming Apparatus 1

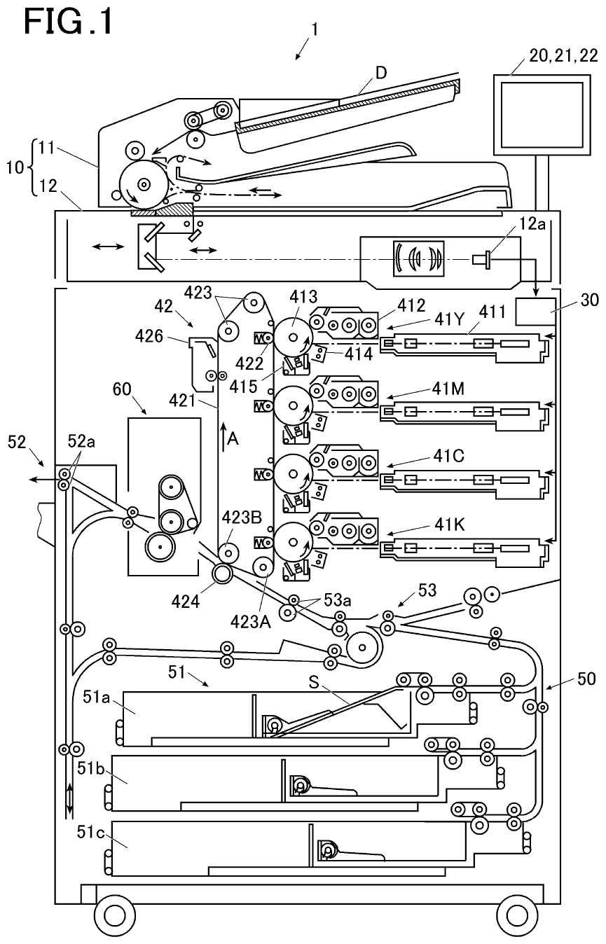

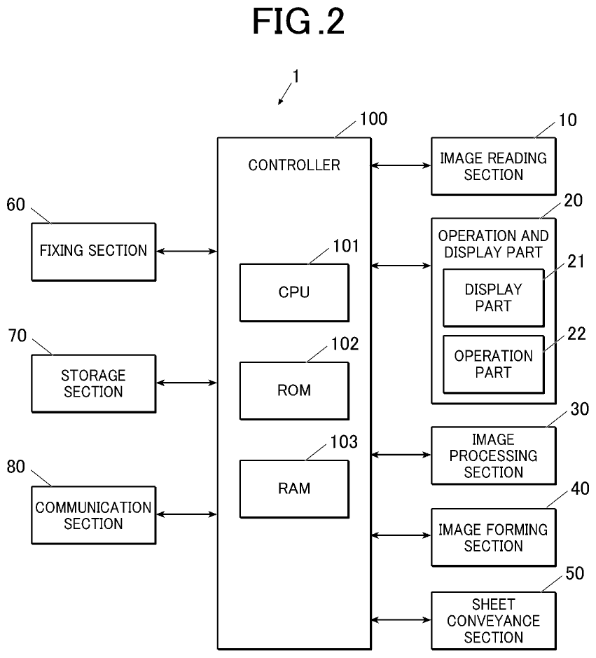

FIG. 1 is a diagram schematically illustrating an overall configuration of an image forming apparatus 1 according to an embodiment of the present disclosure. FIG. 2 is a block diagram that indicates a main functional configuration of the image forming apparatus 1 according to the present embodiment.

The image forming apparatus 1 illustrated in FIG. 1 and FIG. 2 is an intermediate transfer method color image forming apparatus utilizing an electrophotographic process technique. The image forming apparatus 1 transfers (primary transfer) toner images of respective colors of Y (yellow), M (magenta), C (cyan), and K (black) formed on a photosensitive drum 413 to an intermediate transfer belt 421. Next, the image forming apparatus 1 superimposes the toner images in four colors on the intermediate transfer belt 421 and then transfers the toner images onto a sheet S (secondary transfer), thereby forming an image.

The image forming apparatus 1 is of a tandem-system in which the photosensitive drums 413 corresponding to four colors of YMCK are arranged in series in a traveling direction of the intermediate transfer belt 421, and the toner images of the respective colors are sequentially transferred to the intermediate transfer belt 421.

As illustrated in FIG. 2, the image forming apparatus 1 includes an image reading section 10, an operation and display part 20, an image processing section 30, an image forming section 40, a sheet conveyance section 50, a fixing section 60, a storage section 70, a communication section 80, and a controller 100 (hardware processor).

The controller 100 includes a central processing unit (CPU) 101, a read only memory (ROM) 102, a random access memory (RAM) 103, and the like.

The CPU 101 reads a program corresponding to a processing content from the ROM 102, deploys the program in the RAM 103, and centrally controls an operation of each block of the image forming apparatus 1 illustrated in FIG. 2 in cooperation with the deployed program.

The image reading section 10 includes an automatic document feed device 11 called an automatic document feeder (ADF), a document image scanning device 12 (scanner), and the like.

The automatic document feed device 11 conveys a document D placed on a document tray by a conveyance mechanism and sends the document D to the document image scanning device 12. The automatic document feed device 11 can continuously read images of a large number of documents D placed on the document tray at once.

The document image scanning device 12 optically scans the document conveyed from the automatic document feed device 11 onto a contact glass or the document placed on the contact glass. Next, the document image scanning device 12 reads a document image by forming an image of reflected light from the document on a light receiving surface of a charge-coupled device (CCD) sensor 12a. The image reading section 10 generates input image data based on a result of reading by the document image scanning device 12. The image processing section 30 performs predetermined image processing on the input image data.

The operation and display part 20 includes, for example, a liquid crystal display (LCD) with a touch screen and functions as a display part 21 and an operation part 22.

The display part 21 displays various kinds of operation screens, a state of an image, operating statuses of the respective functions, and the like in accordance with display control signals received from the controller 100.

The operation part 22 includes various kinds of operation keys such as a numeric keypad and a start key, accepts various kinds of input operation by a user, and outputs an operation signal to the controller 100.

The image processing section 30 includes a circuit and the like that applies digital image processing to image data of an input job (input image data) in accordance with initial settings or user settings. For example, the image processing section 30 applies gradation correction on the basis of gradation correction data under the control of the controller 100. The image processing section 30 applies to the input image data, not only the gradation correction but also various kinds of correction processing such as color correction and shading correction, compression processing, and the like.

The image forming section 40 forms an image with color toners of a Y component, an M component, a C component, and a K component on the basis of the input image data subjected to the image processing by the image processing section 30.

The image forming section 40 includes image forming units 41Y, 41M, 41C, and 41K, an intermediate transfer unit 42, and the like.

The image forming units 41Y, 41M, 41C, and 41K for the Y component, the M component, the C component, and the K component have a similar configuration. For convenience of illustration and description, common constituent elements are denoted by the same reference numerals, and when they are distinguished from each other, Y, M, C, or K is added to the reference numerals. In FIG. 1, reference numerals are only provided to the constituent elements of the image forming unit 41Y for the Y components and the reference numbers of the constituent elements of the other image forming units 41M, 41C, 41K are omitted.

The image forming unit 41 includes an exposure device 411, a developing device 412, a photosensitive drum 413, a charging device 414, a drum cleaning device 415, and the like.

The photosensitive drum 413 is, for example, an organic photoreceptor in which a photosensitive layer that is a resin containing an organic photoconductor is formed on an outer periphery surface of a drum-shaped metal substrate. The photosensitive drum 413 functions as a latent image bearing member.

The controller 100 controls drive current supplied to a drive motor (not illustrated) that rotates the photosensitive drum 413, thereby rotating the photosensitive drum 413 at a constant circumferential velocity.

The charging device 414 is, for example, a charging charger, and uniformly charges the surface of the photosensitive drum 413 having photoconductivity to a negative polarity by generating corona discharge.

The exposure device 411 includes, for example, a semiconductor laser and irradiates the photosensitive drum 413 with laser light corresponding to the image in each color component. Thus, the exposure device 411 forms an electrostatic latent image of each color component in an image region of the surface of the photosensitive drum 413 irradiated with the laser light, due to a potential difference from a background region.

The developing device 412 is a developing device of a two-component developing method and forms the toner image by visualizing the electrostatic latent image by causing toner of each of the color components to adhere to the surface of the photosensitive drum 413. Details will be described later.

The drum cleaning device 415 includes a drum cleaning blade that comes in sliding contact with the surface of the photosensitive drum 413. The drum cleaning device 415 removes residual toner that is not transferred and that remains on the surface of the photosensitive drum 413 after the primary transfer.

The intermediate transfer unit 42 includes an intermediate transfer belt 421, a primary transfer roller 422, a plurality of support rollers 423, a secondary transfer roller 424, and a belt cleaning device 426.

The intermediate transfer belt 421 is an endless belt and is stretched in a loop around the plurality of support rollers 423. At least one of the plurality of support rollers 423 is a drive roller, and the others are driven rollers. For example, preferably, a roller 423A arranged more on a downstream side in a belt traveling direction than the primary transfer roller 422 for the K component is the drive roller. This allows moving speed of the belt in a primary transfer section to be easily kept constant. The rotation of the roller 423A causes the intermediate transfer belt 421 to move in an arrow direction A at a constant speed.

The primary transfer roller 422 is arranged on an inner periphery surface side of the intermediate transfer belt 421 in a manner facing the photosensitive drum 413 of each color component.

The intermediate transfer unit 42 presses the primary transfer roller 422 against the photosensitive drum 413 with the intermediate transfer belt 421 interposed therebetween. Thus, the intermediate transfer unit 42 forms a primary transfer nip for transferring the toner image from the photosensitive drum 413 to the intermediate transfer belt 421.

The secondary transfer roller 424 is disposed on the outer peripheral surface side of the intermediate transfer belt 421 so as to face a backup roller 423B disposed on the downstream side of the roller 423A in the belt traveling direction.

The intermediate transfer unit 42 presses the secondary transfer roller 424 against the backup roller 423B with the intermediate transfer belt 421 in between. Thus, the intermediate transfer unit 42 forms a secondary transfer nip for transferring the toner image onto the sheet S from the intermediate transfer belt 421.

The intermediate transfer unit 42 primarily transfers the toner image on the photosensitive drum 413 sequentially in a superimposed manner onto the intermediate transfer belt 421 when the intermediate transfer belt 421 passes through the primary transfer nips. Specifically, the intermediate transfer unit 42 applies a primary transfer bias to the primary transfer roller 422 and applies a charge having a polarity opposite to that of the toner to the side of the intermediate transfer belt 421 that abuts the primary transfer roller 422. Thus, the intermediate transfer unit 42 electrostatically transfers the toner image onto the intermediate transfer belt 421.

Thereafter, when the sheet S passes through the secondary transfer nip, the intermediate transfer unit 42 secondarily transfers the toner image on the intermediate transfer belt 421 to the sheet S. Specifically, the intermediate transfer unit 42 applies a secondary transfer bias to the secondary transfer roller 424, and applies an electric charge having a polarity opposite to that of the toner to the side of the sheet S that abuts the secondary transfer roller 424. Thus, the intermediate transfer unit 42 electrostatically transfers the toner image onto the sheet S. The sheet conveyance section 50 conveys the sheet S having the toner image transferred thereon toward the fixing section 60.

The belt cleaning device 426 includes a belt cleaning blade and the like that comes into sliding contact with the surface of the intermediate transfer belt 421. The belt cleaning device 426 removes transfer residual toner remaining on the surface of the intermediate transfer belt 421 after the secondary transfer.

The intermediate transfer unit 42 may have a configuration in which, instead of the secondary transfer roller 424, the secondary transfer belt is stretched in a loop shape around the plurality of support rollers including the secondary transfer roller. The above-described configuration is a so-called belt-type secondary transfer unit.

The fixing section 60 applies heating and pressurizing to the conveyed sheet S on which the toner image has been secondarily transferred, thereby fixing the toner image on the sheet S.

The sheet conveyance section 50 includes a sheet feed section 51, a sheet ejection section 52, a conveyance route section 53, and the like.

Each of the sheet S identified on the basis of a basis weight, a size, and the like is stored according to a preset paper type (a standard sheet or a special sheet) in each of three respective sheet feed tray units 51a to 51c included in the sheet feed section 51.

The conveyance route section 53 includes a plurality of conveyance roller pairs such as a registration roller pair 53a.

The sheet conveyance section 50 feeds the sheets S contained in the sheet feed tray units 51a to 51c one by one from the top and conveys them to the image forming section 40 by the conveyance route section 53. At this time, a registration roller section in which a registration roller pair 53a is arranged corrects an inclination of the fed sheet S and adjusts a conveyance timing. Next, the image forming section 40 collectively secondarily transfers the toner image on the intermediate transfer belt 421 to one surface of the sheet S. Next, the fixing section 60 fixes the secondary transferred toner image onto the sheet. Next, the sheet conveyance section 50 ejects the sheet S on which the image is formed to the outside of the apparatus by the sheet ejection section 52 having a sheet ejection roller 52a.

The storage section 70 includes, for example, a nonvolatile semiconductor memory and a hard disk drive. The storage section 70 stores various types of data such as various types of setting information related to the image forming apparatus 1.

The communication section 80 includes a communication control card such as a local area network (LAN) card. The communication section 80 transmits and receives various types of data to and from an external device (e.g., a personal computer) connected to a communication network such as a LAN or a wide area network (WAN).

### 2. Configuration of Developing Device 412

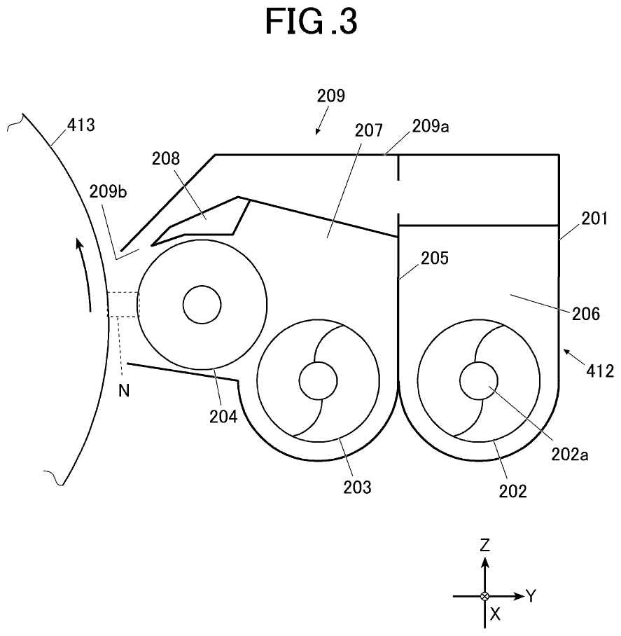

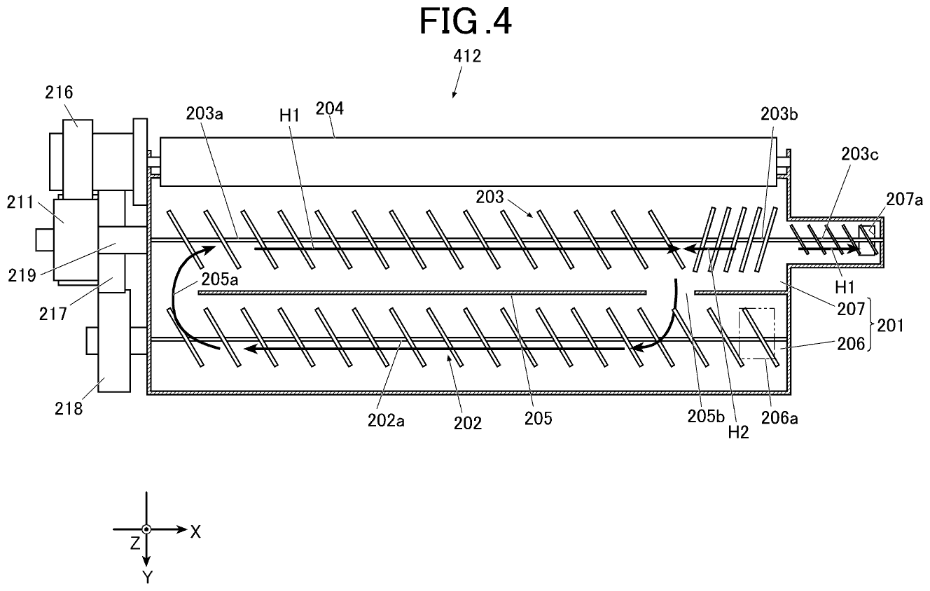

Next, the configuration of the developing device 412 will be described in detail with reference to FIG. 3 and FIG. 4. FIG. 3 is a schematic sectional view in a YZ plane in the vicinity of the developing device 412. FIG. 4 is a schematic diagram of the vicinity of the developing device 412 as viewed from above.

The developing device 412 performs the two-component developing method, and develops the electrostatic latent image formed on the photosensitive drum 413 using a two-component developer containing a toner and a carrier. Thus, the developing device 412 forms the toner image on the photosensitive drum 413.

The developing device 412 includes a developer housing 201.

The developer housing 201 stores the developer containing the toner and the carrier. The developer housing 201 includes a toner conveyance member 202, a toner supply member 203, and a developing roller 204 therein.

In the example illustrated in FIG. 3 and FIG. 4, a direction parallel to a rotation axis 202a of the toner conveyance member 202 is an X-axis direction, a direction horizontal and orthogonal to the X-axis direction is a Y-axis direction, and a vertical direction orthogonal to both the X-axis direction and the Y-axis direction is a Z-axis direction.

The toner conveyance member 202 and the toner supply member 203 are arranged along the axis direction (X-axis direction) of the developing roller 204. Each of the toner conveyance member 202 and the toner supply member 203 is a screw-shaped member including a central axis and a blade body spirally formed around the central axis.

The developer housing 201 includes a storage chamber 206 that accommodates the toner conveyance member 202, and a storage chamber 207 that accommodates the toner supply member 203. The storage chamber 206 and the storage chamber 207 are partitioned by a partition wall 205 disposed along an XZ plane.

The toner conveyance member 202 and the toner supply member 203 are arranged in parallel with the partition wall 205 interposed therebetween.

As illustrated in FIG. 4, the toner supply member 203 includes a supply screw 203a, a reverse winding screw 203b, and a discharge screw 203c that are coaxially arranged in this order.

The supply screw 203a supplies the developer to the developing roller 204.

In the following description, a direction in which the developer is conveyed by normal rotation of the supply screw 203a is referred to as a “first conveyance direction H1”, and a direction opposite thereto is referred to as a “second conveyance direction H2”.

The reverse winding screw 203b is provided on the X-axis positive direction side of the supply screw 203a and conveys the developer in a direction opposite to the supply screw 203a.

The discharge screw 203c is provided on the X-axis positive direction side of the reverse winding screw 203b.

The supply screw 203a conveys the developer in the first conveyance direction H1 during its normal rotation. The reverse winding screw 203b conveys the developer in the second conveyance direction H2 during its normal rotation. The discharge screw 203c conveys, during its normal rotation, the developer in the first conveyance direction H1 equal to the supply screw 203a. Thus, the developer conveyed by the normal rotation of the supply screw 203a is hardly conveyed to the X-axis positive direction side relative to the reverse winding screw 203b. In this case, the developer conveyed during the normal rotation of the supply screw 203a does not advance to the side of the reverse winding screw 203b but is conveyed to the side of the toner conveyance member 202 by bending its path.

As illustrated in FIG. 4, the storage chamber 207 includes a discharge port 207a for discharging the developer at an end portion in the X-axis positive direction.

The discharge port 207a is open downward from the inner bottom part of the storage chamber 207. The developer discharged from the discharge port 207a drops and is stored in a waste developer storage section (not illustrated).

The toner conveyance member 202 conveys the developer in a direction opposite to the supply screw 203a by being rotationally driven in the normal rotation direction.

As shown in FIG. 4, the storage chamber 206 includes a supply port 206a for supplying the developer into the developer housing 201 at an end portion in the X-axis positive direction.

Above the supply port 206a of the developer housing 201, a supply section (not illustrated) is arranged which includes a developer storage section in which the developer for supply is stored and a conveyance mechanism which conveys the developer for supply from the developer storage section. The developer for supply is replenished to the storage chamber 206 from above through the supply port 206a. The supplied developer for supply joins the developer circulating through an annular circulation path in the developer housing 201 and is conveyed by the toner conveyance member 202.

As illustrated in FIG. 4, the partition wall 205 includes openings 205a and 205b.

The opening 205a delivers the developer from the toner conveyance member 202 to the supply screw 203a.

The opening 205b delivers the developer from the supply screw 203a to the toner conveyance member 202.

Thus, the developer circulates between the storage chamber 206 and the storage chamber 207. Some of the developer conveyed by the toner supply member 203 are supplied to the developing roller 204, and the developer is magnetically attracted to the outer circumferential surface of the developing roller 204.

The image forming apparatus 1 replenishes the toner decreased by consumption at the time of image formation by replenishing the developer from the supply port 206a. At the same time, the image forming apparatus 1 discharges the developer through the discharge port 207a. Thus, the image forming apparatus 1 replaces the deteriorated carrier in the developer housing 201 with the new carrier to be supplied, thereby suppressing deterioration of the carrier circulating in the developer housing 201.

A rotation ratio between the toner supply member 203 and the toner conveyance member 202 during the normal rotation, the opening widths of the openings 205a, 205b, and a number of turns of the reverse winding screw 203b are set to values with which an amount of the developer in the developer housing 201 can be maintained at a predetermined amount.

In the present embodiment, the rotational speed of the toner supply member 203 is 466 rpm, and the rotational speed of the toner conveyance member 202 is 491 rpm. The rotational speed ratio between the toner supply member 203 and the toner conveyance member 202 is 0.95:1. In the present embodiment, the opening widths of the openings 205a and 205b are 32.5 mm, and the number of turns of the reverse winding screw 203b is 7.

The developing roller 204 faces the photosensitive drum 413 at the opening of the developer housing 201. For example, the developing roller 204 conveys the developer attracted on the outer periphery surface thereof toward a developing nip (or developing region) N that is an opposed portion to the photosensitive drum 413. The developing roller 204 supplies toner to the photosensitive drum 413 at the developing nip N.

The developing device 412 includes a prevention member 208 provided on an upper side of the developing roller 204.

The prevention member 208 suppresses smoke (scattered toner) due to the developer, which is generated during rotation of the developing roller 204.

The developing device 412 includes a suction section 209 that sucks scattered toner generated between the photosensitive drum 413 and the developing roller 204.

The suction section 209 includes a duct 209a disposed along an outer surface on the upper side of the developer housing 201 and a fan (not illustrated). A suction port 209b, which is a tip end portion of the duct 209a, is installed at a position close to the developing roller 204 on the surface of the photosensitive drum 413. The fan included in the suction section 209 sucks air in the duct 209a. Thus, the scattered toner generated between the photosensitive drum 413 and the developing roller 204 is taken into the duct 209a from the suction port 209b. After being conveyed through the duct 209a, the scattered toner is collected in a collection tank (not shown).

The controller 100 controls start and stop of rotation of the fan included in the suction section 209, change in rotational speed of the fan, and the like.

In the suction section 209, there is a problem in that the toner is accumulated on the wall surface of the duct 209a or the like, and the accumulated toner spills onto the photosensitive drum 413 or the sheet, thus causing the inside of the image forming apparatus 1 to be contaminated or causing the image defect in which the image is made dirty.

In particular, in the vicinity of the suction port 209b, a laminar flow generated by the rotation of the developing roller 204 and the laminar flow generated by the rotation of the photosensitive drum 413 intersect with each other, and a spiral airflow is generated. Therefore, even if an air flow speed of suction in the suction section 209 is increased, the toner cannot be completely sucked and collected in the vicinity of the suction port 209b and the toner is likely to be deposited. The vicinity of the suction port 209b is, for example, a tip end portion (an end portion on the photosensitive drum 413 side) of the prevention member 208.

In the present embodiment, the image forming apparatus 1 crushes the toner accumulated on the prevention member 208 by applying vibration to the prevention member 208. Next, the image forming apparatus 1 collects the crushed toner by suction using the suction section 209 or causes the crushed toner to adhere to the developing roller 204, thereby reducing the toner accumulated on the prevention member 208. Thus, the image forming apparatus 1 suppresses the image defect due to spillage of the deposited toner onto the photosensitive drum 413 or the sheet.

### 3. Configuration of Drive Mechanism 210

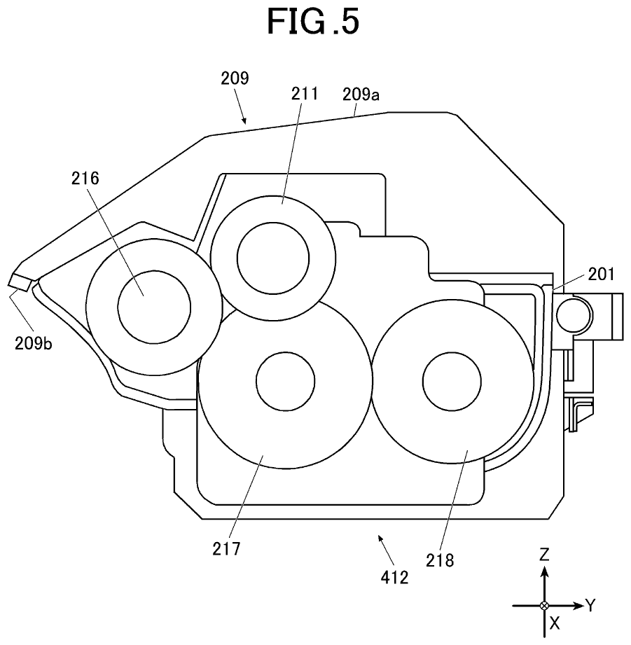

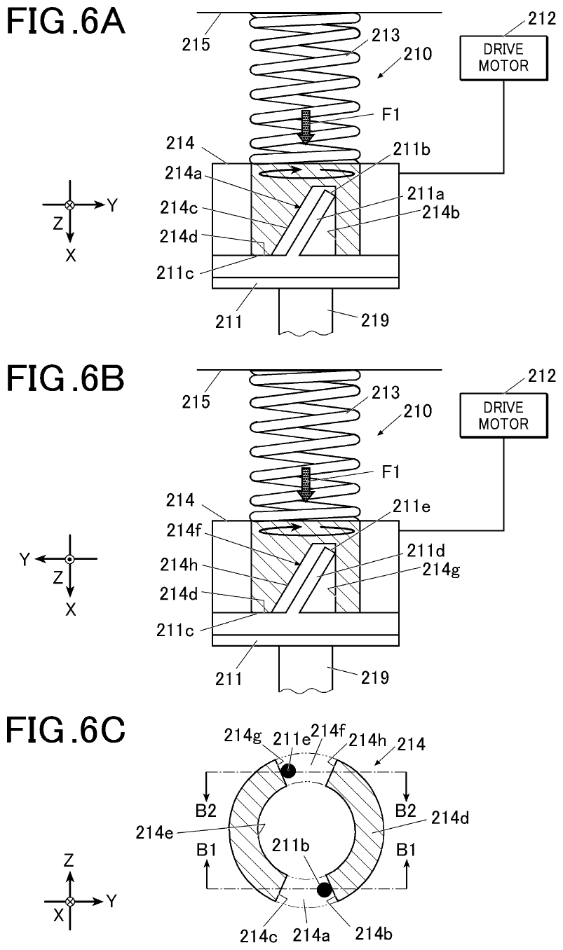

FIG. 5 is a schematic side view of the vicinity of the developing device 412, and FIG. 6A to FIG. 6C are schematic diagrams showing a part of a configuration of a drive mechanism 210 included in the developing device 412.

As illustrated in FIG. 4 to FIG. 6C, the drive mechanism 210 includes an idler gear 211 (second member), a drive motor 212, an elastic member 213, a drive transmission member 214 (first member), a developing roller gear 216, a toner supply member gear 217, and a toner conveyance member gear 218.

In the present embodiment, the drive transmission member 214 (first member), the idler gear 211 (second member), and the controller 100 are included in a control device.

The developing roller gear 216 transmits, to the developing roller 204, a rotational driving force for rotationally driving the developing roller 204.

The toner supply member gear 217 transmits, to the toner supply member 203, a rotational driving force for rotationally driving the toner supply member 203.

The toner conveyance member gear 218 transmits, to the toner conveyance member 202, a rotational driving force for rotationally driving the toner conveyance member 202.

The idler gear 211 transmits a rotational driving force outputted from the drive motor 212 to the developing roller gear 216, the toner supply member gear 217, and the toner conveyance member gear 218 via a drive transmission member 214.

As shown in FIG. 6A and FIG. 6B, the idler gear 211 is provided with engaged portions 211a and 211d disposed at an equal interval on an opposing surface 211c which is a surface opposing the drive transmission member 214.

The engaged portions 211a and 211d protrude in a X-axis negative direction side at a predetermined angle with respect to the X-axis direction.

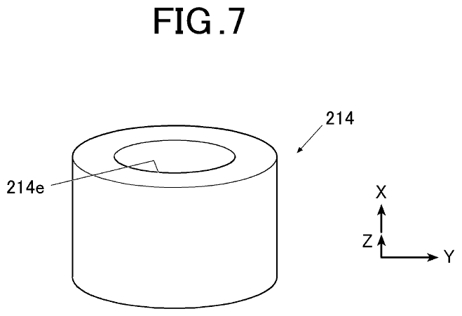

The drive transmission member 214 is a substantially cylindrical member as shown in FIG. 7.

FIG. 6C is a schematic diagram illustrating a positional relationship between the drive transmission member 214 and an end portion 211b of the engaged portion 211a and a positional relationship between the drive transmission member 214 and an end portion 211e of the engaged portion 211d when viewed from the X-axis negative direction.

A hatched portion of the drive transmission member 214 illustrated in FIG. 6A is a cross-sectional view taken along a line B1 to B1 shown in FIG. 6C. A hatched portion of the drive transmission member 214 illustrated in FIG. 6B is a cross-sectional view taken along a line B2 to B2 illustrated in FIG. 6C.

Under the control of the controller 100, the drive motor 212 rotates the drive transmission member 214 about a rotation axis parallel to the X-axis direction while switching between a first direction and a second direction. The first direction is a normal rotation direction and is clockwise when viewed from the X-axis negative direction side. The second direction is a reverse rotation direction and is a counterclockwise direction when viewed from the X-axis negative direction side in a direction opposite to the first direction.

The elastic member 213 is a spring or the like provided along the X-axis direction between an inner wall surface 215 of a housing of the image forming apparatus 1 and the drive transmission member 214. The elastic member 213 is extendable in the X-axis direction.

The drive transmission member 214 includes engagement portions 214a and 214f disposed at equal intervals on an opposing surface 214d facing the idler gear 211.

The engaged portions 211a and 211d of the idler gear 211 can be positioned within the engagement portions 214a and 214f. To be specific, in a state where the engaged portion 211a is disposed in the engagement portion 214a, the engaged portion 211d is disposed in the engagement portion 214f. In a state where the engaged portion 211d is placed in the engagement portion 214a, the engaged portion 211a is placed in the engagement portion 214f.

The engagement portion 214a and 214f have a substantially right angled trapezoidal shape in the XY plane.

The engagement portion 214a includes a parallel section 214b that is parallel to the X-axis and an inclined part 214c that is inclined at a predetermined angle with respect to the X-axis.

The engagement portion 214f includes a parallel section 214g that is parallel to the X-axis and an inclined part 214h that is inclined at a predetermined angle with respect to the X-axis.

The angle at which the inclined parts 214c and 214h are inclined relative to the X-axis is substantially the same as the angle at which the engaged portions 211a and 211d of the idler gear 211 are inclined relative to the X-axis.

As shown in FIG. 7, the drive transmission member 214 includes a through hole 214e at the center in the YZ plane. The through hole 214e penetrates the drive transmission member 214 in the X-axis direction. A rotation axis of the drive transmission member 214 is inserted into the through hole 214e.

### 4. Rotation Operation in First Direction

Next, a description will be provided on the operation of the developing device 412 in a case where the drive transmission member 214 rotates in the first direction.

In the state illustrated in FIG. 6A and FIG. 6B, the drive transmission member 214 is biased toward the idler gear 211 side by the elastic force F1 of the elastic member 213.

The engaged portion 211a of the idler gear 211 is located within the engagement portion 214a of the drive transmission member 214. The end portion 211b of the engaged portion 211a abuts the parallel section 214b of the engagement portion 214a.

The engaged portion 211d of the idler gear 211 is located within the engagement portion 214f of the drive transmission member 214. The end portion 211e of the engaged portion 211d abuts the parallel section 214g of the engagement portion 214f.

The opposing surface 214d of the drive transmission member 214 abuts the opposing surface 211c of the idler gear 211.

This state is referred to as an engaged state of the engagement portions 214a and 214f and the engaged portions 211a and 211d.

In the engaged state, the controller 100 drives the drive motor 212 such that the drive transmission member 214 rotates in the first direction. The rotational driving force of the drive motor 212 is transmitted to the idler gear 211 via the engagement portions 214a and 214f and the engaged portions 211a and 211d that are in the engaged state.

At this time, the drive transmission member 214 transmits the rotational driving force of the drive motor 212 to the developing roller 204 via the developing roller gear 216 that meshes with the idler gear 211.

The drive transmission member 214 transmits the rotational driving force of the drive motor 212 to the toner supply member 203 via the toner supply member gear 217 that meshes with the idler gear 211.

The drive transmission member 214 transmits the rotational driving force of the drive motor 212 to the toner conveyance member 202 via the toner conveyance member gear 218 that meshes with the toner supply member gear 217.

At this time, a conveying force with which the toner conveyance member 202 conveys the developer by rotating in the first direction by the rotational driving force of the drive motor 212 is greater than the load that the toner conveyance member 202 receives from the developer stored in the storage chamber 206. Therefore, the toner conveyance member 202 rotates in the first direction about the rotation axis 202a. As a result, the developer stored in the storage chamber 206 is conveyed from the X-axis positive direction side to the X-axis negative direction side. This is the case where the drive transmission member 214 transmits, to the idler gear 211, the rotational driving force of the drive motor 212 that is greater than the rotational load of the idler gear 211. At this time, the idler gear 211 rotates in the first direction about the idler shaft 219 that is parallel to the X-axis direction.

In this case, the developing roller 204 is rotated by the rotational driving force of the drive motor 212 around the rotation axis parallel to the X-axis direction in the counterclockwise direction when viewed from the X-axis negative direction side. The developing roller 204 supplies the toner to the photosensitive drum 413 at the developing nip N by rotating.

The toner supply member 203 rotates counterclockwise as viewed from the X-axis negative direction side, about the rotation axis parallel to the X-axis, by the rotational driving force of the drive motor 212. The toner supply member 203 supplies the developer to the developing roller 204 by rotating.

In the rotating operation in the first direction, the drive transmission member 214 and the idler gear 211 rotate in the first direction with the engagement portions 214a and 214f and the engaged portions 211a and 211d remaining in the state engaged with each other.

As described above, the controller 100 executes the first operation of rotating the drive transmission member 214 in the first direction in the state where the engagement portions 214a and 214f and the engaged portions 211a and 211d are engaged with each other. Thus, the controller 100 causes the drive transmission member 214 to transmit a driving force greater than the rotational load of the idler gear 211 to the idler gear 211 to rotate the idler gear 211 in the first direction, thereby performing the developing process.

The drive transmission member 214 transmits the rotational driving force of the drive motor 212 to the idler gear 211 via the engagement portions 214a and 214f and the engaged portions 211a and 211d that are in the engaged state in the first operation.

### 5. Rotation Operation in Second Direction

Next, the operation of the developing device 412 in a case where the drive transmission member 214 rotates in the second direction will be described.

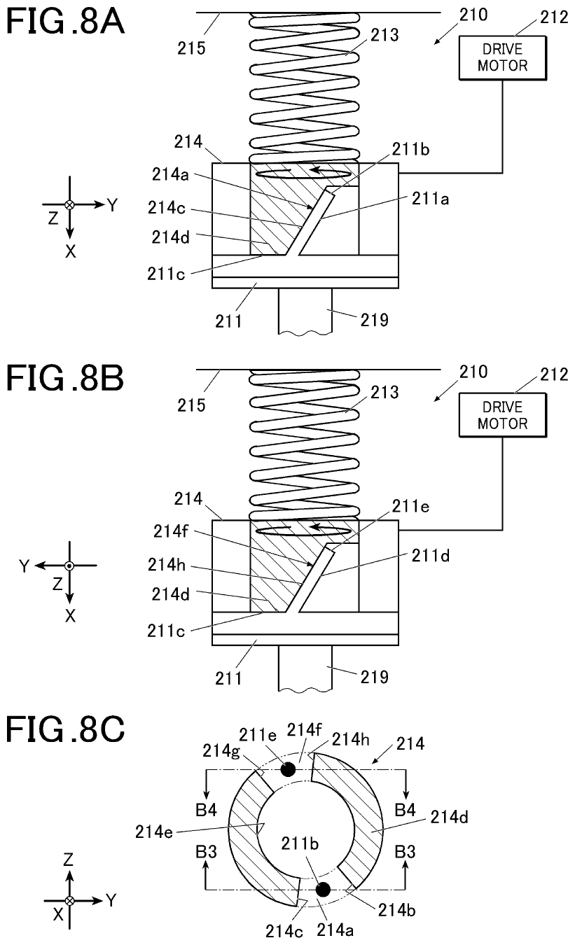

FIG. 8A to FIG. 13C are schematic diagrams illustrating a part of the configuration of the drive mechanism 210 in a case where the drive transmission member 214 rotates in the second direction.

The controller 100 drives the drive motor 212 such that the drive transmission member 214 rotates in the second direction from the state where the engagement portions 214a and 214f and the engaged portions 211a and 211d are engaged with each other.

When the drive transmission member 214 rotates in the second direction, as shown in FIG. 8A, the engaged portion 211a abuts the inclined part 214c of the engagement portion 214a. In addition, as shown in FIG. 8B, the engaged portion 211d abuts against the inclined part 214h of the engagement portion 214f.

A hatched portion of the drive transmission member 214 illustrated in FIG. 8A is a cross-sectional view taken along a line B3 to B3 illustrated in FIG. 8C. A hatched portion of the drive transmission member 214 illustrated in FIG. 8B is a cross-sectional view taken along a line B4 to B4 illustrated in FIG. 8C.

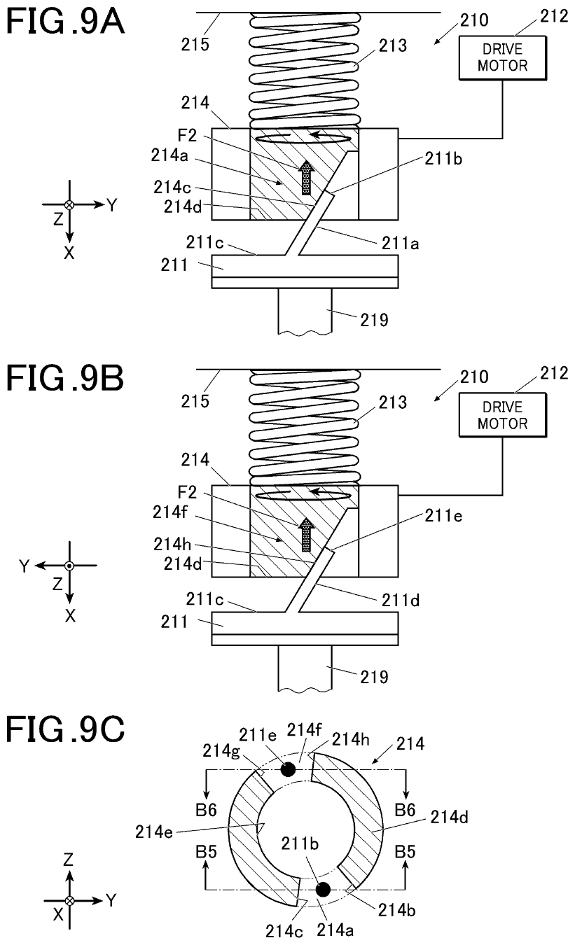

FIG. 9A to FIG. 9C illustrate a state where the controller 100 further rotates the drive transmission member 214 in the second direction from the state illustrated in FIG. 8A to FIG. 8C. In the present embodiment, when the drive transmission member 214 rotates in the second direction, the load that the toner conveyance member 202 receives from the developer stored in the storage chamber 206 is greater than the conveying force with which the toner conveyance member 202 conveys the developer by rotating in the second direction. That is, the rotational load of the idler gear 211 in the rotation operation in the second direction is greater than the rotational driving force by the drive motor 212. Therefore, the idler gear 211 does not rotate and remains stopped.

At this time, as illustrated in FIG. 9A, the engagement portion 214a receives force F2 from the engaged portion 211a at the inclined part 214c. In addition, as shown in FIG. 9B, the engagement portion 214f receives the force F2 from the engaged portion 211d at the inclined part 214h.

A hatched portion of the drive transmission member 214 illustrated in FIG. 9A is a cross-sectional view taken along a line B5 to B5 illustrated in FIG. 9C. A hatched portion of the drive transmission member 214 illustrated in FIG. 9B is a cross-sectional view taken along a line B6 to B6 illustrated in FIG. 9C.

When the engagement portions 214a and 214f receive the force F2, the drive transmission member 214 moves toward the X-axis negative direction side, and the opposing surface 214d of the drive transmission member 214 and the opposing surface 211c of the idler gear 211 are separated from each other. Thus, the elastic member 213 contracts in the X-axis direction.

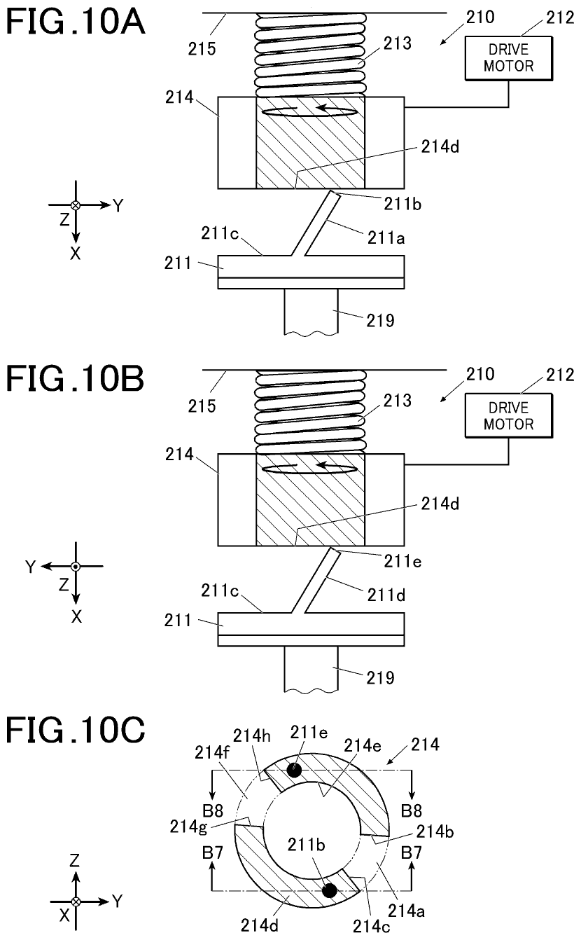

FIG. 10A to FIG. 10C illustrate a state where the controller 100 further rotates the drive transmission member 214 in the second direction from the state illustrated in FIG. 9A to FIG. 9C.

As illustrated in FIG. 10A and FIG. 10B, the drive transmission member 214 further moves toward the X-axis negative direction side.

A hatched portion of the drive transmission member 214 illustrated in FIG. 10A is a cross-sectional view taken along a line B7 to B7 illustrated in FIG. 10C. A hatched portion of the drive transmission member 214 illustrated in FIG. 10B is a cross-sectional view taken along a line B8 to B8 illustrated in FIG. 10C.

As the drive transmission member 214 moves further toward the X-axis negative direction side, the engaged portion 211a of the idler gear 211 disengages from the engagement portion 214a of the drive transmission member 214. At the same time, the engaged portion 211d of the idler gear 211 is disengaged from the engagement portion 214f of the drive transmission member 214. The end portion 211b of the engaged portion 211a and the end portion 211e of the engaged portion 211d abut against the opposing surface 214d of the drive transmission member 214. The elastic member 213 further contracts in the X-axis direction. The elastic member 213 illustrated in FIG. 10A and FIG. 10B is in a most contracted state.

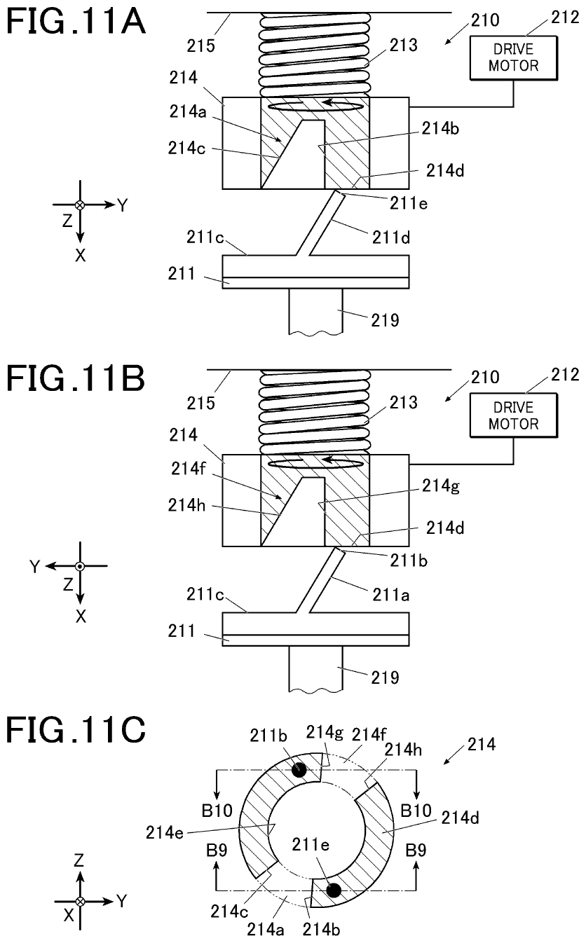

FIG. 11A to FIG. 11C illustrates a state where the controller 100 further rotates the drive transmission member 214 in the second direction from the state illustrated in FIG. 10A to FIG. 10C.

As illustrated in FIG. 11A and FIG. 11B, the end portion 211b of the engaged portion 211a and the end portion 211e of the engaged portion 211d abut the opposing surface 214d of the drive transmission member 214, and the drive transmission member 214 rotates in the second direction with the elastic member 213 remaining in the most contracted state.

A hatched portion of the drive transmission member 214 illustrated in FIG. 11A is a cross-sectional view taken along a line B9 to B9 illustrated in FIG. 11C. A hatched portion of the drive transmission member 214 illustrated in FIG. 11B is a cross-sectional view taken along a line B10 to B10 illustrated in FIG. 11C.

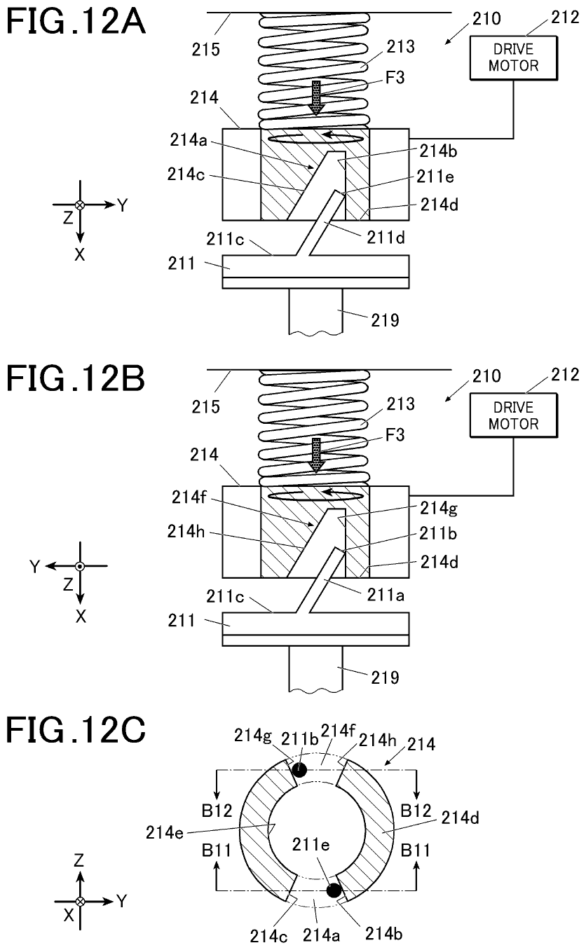

FIG. 12A to FIG. 12C illustrate a state where the controller 100 further rotates the drive transmission member 214 in the second direction from the state illustrated in FIG. 11A to FIG. 11C.

As illustrated in FIG. 12A, the end portion 211e of the engaged portion 211d reaches the position of the parallel section 214b of the engagement portion 214a, and the end portion 211e abuts on the parallel section 214b. A hatched portion of the drive transmission member 214 illustrated in FIG. 12A is a cross-sectional view taken along a line B11 to B11 illustrated in FIG. 12C.

As illustrated in FIG. 12B, the end portion 211b of the engaged portion 211a reaches the position of the parallel section 214g of the engagement portion 214f, and the end portion 211b abuts on the parallel section 214g. A hatched portion of the drive transmission member 214 illustrated in FIG. 12B is a cross-sectional view taken along a line B12 to B12 illustrated in FIG. 12C.

When the end portion 211e abuts the parallel section 214b and the end portion 211b abuts the parallel section 214g, the contraction of the elastic member 213 is released. As a result, the drive transmission member 214 moves toward the X-axis positive direction side due to the elastic repulsive force F3 of the elastic member 213.

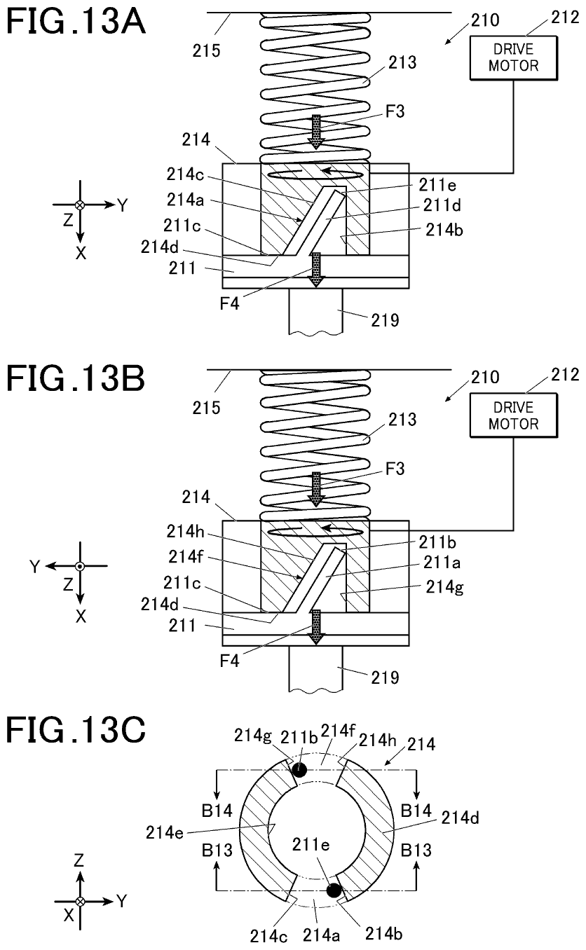

FIG. 13A to FIG. 13C illustrate a state where the controller 100 further rotates the drive transmission member 214 in the second direction from the state illustrated in FIG. 12A to FIG. 12C.

As shown in FIG. 13A, the end portion 211e of the engaged portion 211d abuts the parallel section 214b of the engagement portion 214a. A hatched portion of the drive transmission member 214 illustrated in FIG. 13A is a cross-sectional view taken along a line B13 to B13 illustrated in FIG. 13C.

As shown in FIG. 13B, the end portion 211b of the engaged portion 211a abuts the parallel section 214g of the engagement portion 214f. A hatched portion of the drive transmission member 214 illustrated in FIG. 13B is a cross-sectional view taken along a line B14 to B14 illustrated in FIG. 13C.

The drive transmission member 214 is further moved toward the X-axis positive direction side by the elastic repulsive force F3 of the elastic member 213. Thus, the drive transmission member 214 collides, at the opposing surface 214d, with the opposing surface 211c of the idler gear 211. That is, the elastic repulsive force F3 accumulated in the elastic member 213 is released in a short time, so that the drive transmission member 214 collides with the idler gear 211. Thus, the drive transmission member 214 applies an impact force F4 to the idler gear 211.

The vibration due to the impact force F4 received by the idler gear 211 is transmitted to the prevention member 208 via the developing roller 204, the toner supply member 203, the toner conveyance member 202, the developer housing 201, and the like.

When the prevention member 208 vibrates, the toner deposited on the prevention member 208 is crushed, and the crushed toner is sucked and collected by the suction section 209. Alternatively, the crushed toner adheres to the developing roller 204.

When the controller 100 further rotates the drive transmission member 214 in the second direction from the state illustrated in FIG. 13A to FIG. 13C, the state returns to the state illustrated in FIG. 8A to FIG. 8C. In the states illustrated in FIG. 8A to FIG. 13C, the rotation of the idler gear 211 remains stopped.

The controller 100 causes the drive transmission member 214 to repeatedly collide with the idler gear 211 by continuing to rotate the drive transmission member 214 in the second direction.

As described above, as a second operation, the controller 100 rotates the drive transmission member 214 in the second direction to alternately switch the drive transmission member 214 and the idler gear 211 between the engaged state and the disengaged state. When the drive transmission member 214 and the idler gear 211 are switched from the disengaged state to the engaged state, the controller 100 applies vibration to the idler gear 211 by moving the drive transmission member 214 in a direction parallel to the rotation axis of the drive transmission member 214 and engaging with the idler gear 211.

In the rotational operation in the second direction, the drive transmission member 214 and the idler gear 211 can take an engagement state in which the engagement portions 214a and 214f and the engaged portions 211a and 211d are engaged with each other and a disengaged state in which they are not engaged with each other.

In other words, the idler gear 211 (second member) can be switched between an engaged state in which it is engaged with the drive transmission member 214 (first member) and a disengaged state in which it is not engaged with the drive transmission member 214.

As described above, the controller 100 switches between the first operation and the second operation by switching the rotation direction of the drive transmission member 214.

### 6. Wear at an Engagement Location Between the First Member and the Second Member

After the second operation which is an operation of vibrating the prevention member 208, the position where the drive transmission member 214 stops is random. Therefore, when the drive transmission member 214 is stopped, there is a possibility of the disengaged state in which the engagement portions 214a and 214f and the engaged portions 211a and 211d are not engaged with each other.

For example, after the second operation, there is a possibility that the engaged portion 211a is located in the engagement portion 214a, the engaged portion 211d is located in the engagement portion 214f, the end portion 211b does not abut the parallel section 214b, and the end portion 211e does not abut the parallel section 214g.

Alternatively, after the second operation, the idler gear 211 and the drive transmission member 214 may be in a retracted state illustrated in FIG. 10A to FIG. 10C and FIG. 11A to FIG. 11C.

The retracted state is a state in which the engaged portions 211a and 211d are not located in the engagement portions 214a and 214f, and the end portions 211b and 211e abuts the opposing surface 214d of the drive transmission member 214.

After the second operation, in order to execute the developing process from the disengaged state between the engagement portions 214a and 214f and the engaged portions 211a and 211d, the drive transmission member 214 is rotated in the first direction at a relatively high speed as the first operation.

In this case, when the end portions 211b and 211e and the parallel sections 214b and 214g abut against each other, a strong impact force is generated at the abutting locations. Thus, wear occurs at the abutting locations (engagement locations) between the end portions 211b and 211e and the parallel sections 214b and 214g.

After the second operation, from the retracted state in which the elastic member 213 is most contracted, as the first operation, the drive transmission member 214 is rotated in the first direction in order to execute the developing process.

In this case, if the end portions 211b and 211e and the parallel sections 214b and 214g abut against each other before the elastic member 213 is fully extended and partitioned, the end portions 211b and 211e and the parallel sections 214b and 214g slide in the direction of extension and contraction of the elastic member 213 (the X-axis direction) at the abutting locations. Thus, the wear occurs at the abutting locations (engagement locations) between the end portions 211b and 211e and the parallel sections 214b and 214g.

### 7. Third Operation

In the present embodiment, the controller 100 of the image forming apparatus 1 executes a third operation after the second operation in order to reduce the wear at the abutting location (engagement location) between the end portions 211b and 211e and the parallel sections 214b and 214g. After the end of the third operation, the controller 100 executes the first operation for executing the developing process.

Hereinafter, the third operation executed by the controller 100 will be described.

As the third operation, the controller 100 rotates the drive transmission member 214 in the first direction at a third operation rotational speed to bring the engagement portions 214a and 214f and the engaged portions 211a and 211d into the engaged state. The third operation rotational speed is a speed lower than the rotational speed during the first operation.

After rotating the drive transmission member 214 by a third operation angle or more in the third operation, the controller 100 stops the third operation.

The third operation angle is an angle obtained by dividing 360 degrees by a number of sets of the engagement portions 214a and 214f and the engaged portions 211a and 211d. In the present embodiment, the number of sets of the engagement portions 214a and 214f and the engaged portions 211a and 211d is two.

Thus, the engagement portions 214a and 214f and the engaged portions 211a and 211d can be reliably engaged with each other without generating a strong impact force at the abutting locations between the end portions 211b and 211e and the parallel sections 214b and 214g.

Furthermore, starting the first operation from the engaged state of the engagement portions 214a and 214f and the engaged portions 211a and 211d can reduce the wear at the abutting locations of the end portions 211b and 211e and the parallel sections 214b and 214g.

Hereinafter, the third operation rotational speed will be described in detail.

The time from the most contracted state of the elastic member 213 in the retracted state to when the elastic member 213 is completely extended is referred to as a first time.

In the third operation, the time from the start of the rotation of the drive transmission member 214 in the first direction to the engagement of the engagement portions 214a and 214f with the engaged portions 211a and 211d is defined as a second time.

If the second time is longer than the first time, the abutting location between the end portions 211b and 211e and the parallel sections 214b and 214g can be prevented from sliding in the direction in which the elastic member 213 expands and contracts.

The first time t1 is expressed by the following Expression (1).

$$[ Expression 1 ]$$

$$t 1 = \frac{L 2 - L 1}{\sqrt{\frac{k}{m} \{ {( L 0 - L 1 )}^{2} - {( L 0 - L 2 )}^{2} \}}} \qquad ( 1 )$$

k: spring constant of the elastic member 213
m: mass of the drive transmission member 214
L0: free length of the elastic member 213
L1: length of the elastic member 213 in the state where the elastic member 213 is most contracted in the retracted state
L2: length of the elastic member 213 when the drive transmission member 214 illustrated in FIG. 13A to FIG. 13C collides with the idler gear 211

The second time t2 is expressed by the following Expression (2).

$$[ Expression 2 ]$$

$$t 2 = \frac{θ}{6 R} \qquad ( 2 )$$

θ: rotation angle of the drive transmission member 214 from the start of the rotation of the drive transmission member 214 in the first direction in the third operation until the engagement portions 214a and 214f and the engaged portions 211a and 211d are engaged with each other
R: third operation rotational speed

The third operation rotational speed R in a case where the second time is longer than the first time is expressed by the following Expression (3).

$$[ Expression 3 ]$$

$$R < \frac{θ \sqrt{\frac{k}{m} \{ {( L 0 - L 1 )}^{2} - {( L 0 - L 2 )}^{2} \}}}{6 ( L 2 - L 1 )} \qquad ( 3 )$$

For example, in the above formula (3), m: 0.02 kg, k: 0.2, L0: 28.3 mm, L1: 10.25 mm, L2: 13.75 mm, θ: In the case of 117 deg, the third operation rotation speed R is lower than 188.2 rpm. In this case, the second time is longer than the first time. Therefore, it is possible to prevent the abutting location between the end portions 211b and 211e and the parallel sections 214b and 214g from sliding in the expansion and contraction direction of the elastic member 213.

### 8. Axial Misalignment Between First Member and Second Member

It is ideal that the idler gear 211 and the drive transmission member 214 are disposed so that their rotation axes coincide with each other. However, the idler gear 211 and the drive transmission member 214 are constituted by different units, so that there is a possibility that an axial misalignment in which the rotational axes of the idler gear 211 and the drive transmission member 214 do not coincide with each other occurs due to a component tolerance or the like.

When the axial misalignment occurs, in the first operation, there is a moment when one of the end portions 211b and 211e abuts one of the parallel sections 214b and 214g and the other end portion does not abut the other parallel section. At that time, a high pressure is applied to the end portion and the parallel section which abut each other, and the wear occurs in the end portion and the parallel section which abut each other.

In order to reduce the wear at the abutting locations between the end portions 211b and 211e and the parallel section 214b and 214g due to the axial misalignment, the idler gear 211 and the drive transmission member 214 are preferably formed of a material having a low specific wear amount. The material having a small specific wear amount is, for example, polyether ether ketone (PEEK).

### 9. Others

The developing device 412 may include a sealing member such as urethane foam or a soft sealing material for preventing leakage of the toner stored in the developer housing 201. The sealing member is a soft member capable of filling a gap of the developer housing 201. In a case where the developing roller 204 and the toner conveyance member 202 are connected to the prevention member 208 via the sealing member, the vibration due to the impact force F4 transmitted to the developing roller 204 and the toner conveyance member 202 via the idler gear 211 is suppressed by the elasticity of the sealing member.

Therefore, it is preferable that the developing roller 204 and the toner conveyance member 202 be connected to the prevention member 208 via a rigid body. In this case, the vibration due to the impact force F4 transmitted to the developing roller 204 and the toner conveyance member 202 is less likely to be suppressed and is efficiently transmitted to the prevention member 208. Thus, the toner accumulated on the prevention member 208 can be efficiently crushed. The rigid body includes a plurality of rigid bodies fastened by a fastening member, or a plurality of rigid bodies bonded and integrated by a curable adhesive or the like.

In the second operation, when the drive transmission member 214 applies the impact force F4 to the idler gear 211, a sound is generated by the impact. The user can recognize that the second operation is being performed by the sound. However, when the surroundings of the image forming apparatus 1 are quiet, the user may be anxious about the sound.

Therefore, in the present embodiment, the drive transmission member 214 performs the second operation at the same timing as the charging and cleaning operation performed in the image forming apparatus 1. The charging and cleaning operation is an operation in which a charging cleaning member that cleans a charging wire included in the charging device 414 reciprocates in a direction along the charging wire. In the image forming apparatus 1, the controller 100 executes the charging and cleaning operation every time 3,000 sheets of paper having the A4 size are printed. The controller 100 executes the charging and cleaning operation every time a print job is completed.

Thus, the sound generated in the second operation and the sound generated in the charging and cleaning operation are generated at the same time. Therefore, a situation in which only the sound generated in the second operation of the present embodiment stands out does not occur.

That is, the second operation of the present embodiment is performed at the same time as an operation different from the second operation performed in the image forming apparatus 1.

The drive transmission member 214 may perform the second operation during the operation of the fan included in the image forming apparatus 1. The fan is a fan that prevents a temperature increase in the image forming apparatus 1 and an ozone fan that performs a purification process that causes a filter to adsorb ozone generated in the image forming apparatus 1.

Thus, the sound generated in the second operation and the sound generated by the operation of the fan are generated at the same time. Therefore, a situation in which only the sound generated in the second operation stands out does not occur.

The drive transmission member 214 may perform the second operation during operation of the post-processing apparatus connected to the image forming apparatus 1. The post-processing apparatus is an apparatus that performs post-processing on the sheet on which the image formation has been formed, such as staple, punch, sorting, saddle stitch, and tri-folding.

Thus, the sound generated in the second operation and the sound generated by the operation of the post-processing apparatus are generated at the same time. Therefore, a situation in which only the sound generated in the second operation stands out does not occur.

In the present embodiment, the controller 100 may execute the second operation and the third operation simultaneously with the adjustment operation, the warm-up operation, and the like relating to the image formation processing in the image forming apparatus 1. That is, the controller 100 may perform the second operation and the third operation at the same time as an operation different from the second operation and the third operation performed in the image forming apparatus 1.

Thus, it is not necessary to separately provide time for performing the second operation and the third operation, thereby suppressing a reduction in productivity in the image forming apparatus 1.

### Second Embodiment

Next, an image forming apparatus 1 according to a second embodiment will be described.

In the following description, the same components as those of the image forming apparatus 1 according to the first embodiment are denoted by the same reference signs, and the description thereof will be omitted.

The image forming apparatus 1 of the second embodiment includes a sensing section (not illustrated) that senses that the engagement portions 214a and 214f and the engaged portions 211a and 211d are brought into the engaged state. The sensing section senses the engaged state based on the load of the drive motor 212 when the state changes from the disengaged state in which the engagement portions 214a and 214f and the engaged portions 211a and 211d are not engaged to the engaged state.

The sensing section may sense the engagement state by sensing rotation of the toner conveyance member 202 or the developing roller 204 in the first direction.

The controller 100 of the second embodiment stops the third operation in a case where the sensing section senses the engaged state of the engagement portions 214a and 214f and the engaged portions 211a and 211d in the third operation.

Thus, the end portions 211b and 211e and the parallel sections 214b and 214g can reliably abut each other. Therefore, starting the first operation from the engaged state of the engagement portions 214a and 214f and the engaged portions 211a and 211d can reduce the wear at the abutting locations of the end portions 211b and 211e and the parallel sections 214b and 214g.

### Third Embodiment

Next, the image forming apparatus 1 relating to a third embodiment will be described.

In the following description, the same components as those of the image forming apparatus 1 according to the first embodiment are denoted by the same reference signs, and the description thereof will be omitted.

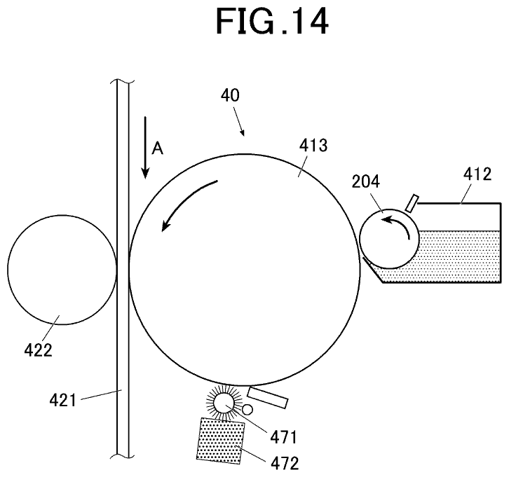

As illustrated in FIG. 14, the image forming section 40 includes a brush roller 471 for applying lubricant to the photosensitive drum 413 and a solid lubricant 472.

The brush roller 471 is rotationally driven to supply lubricant particles scraped from the solid lubricant 472 to the photosensitive drum 413.

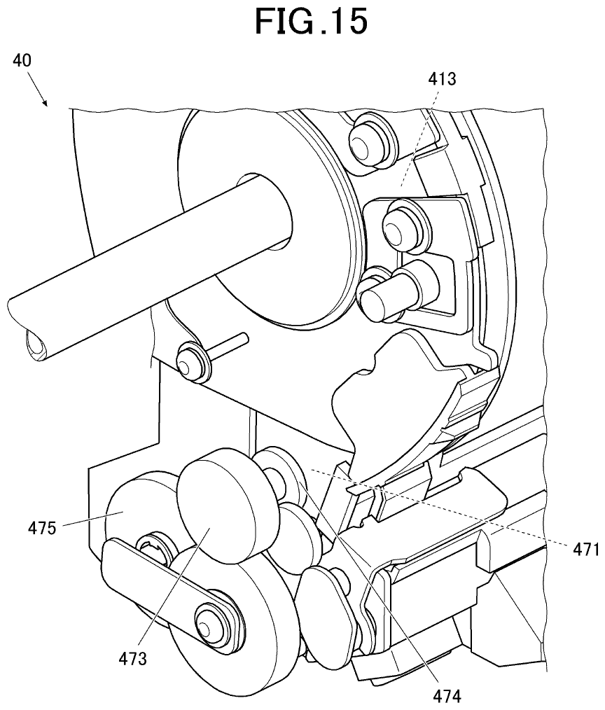

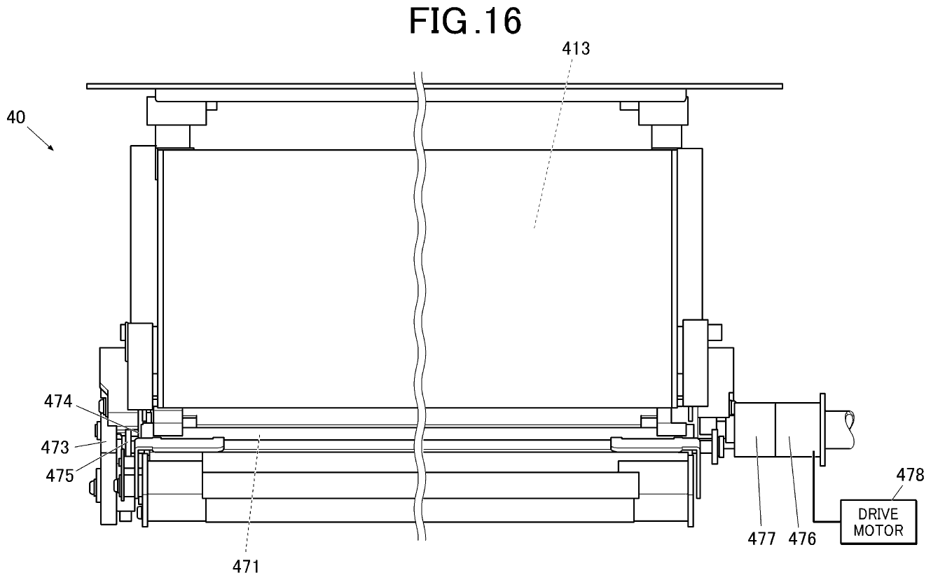

As illustrated in FIG. 15 and FIG. 16, the image forming section 40 includes a brush gear 473, a one-way clutch 474, a waste toner conveyance gear 475, a first member 476, a second member 477, and a drive motor 478.

The first member 476 has the same configuration as the drive transmission member 214 in the above-described first embodiment, and the second member 477 has the same configuration as the idler gear 211 in the above-described first embodiment.

The one-way clutch 474 does not restrict rotation of the brush roller 471 in the first direction in the first operation. On the other hand, the one-way clutch 474 restricts the brush roller 471 and the second member 477 from rotating in the second direction in the second operation.

The image forming section 40 includes a waste toner conveyance member (waste toner conveyor) and a waste toner conveyance route (not shown).

The waste toner conveyance member is a screw-like member including a central axis and a blade body spirally formed around the central axis. The waste toner conveyance member is disposed in a waste toner conveyance route and conveys waste toner.

In the third embodiment, the controller 100, the first member 476, the second member 477, the waste toner conveyance route, the waste toner conveyance member, and the drive motor 478 are included in a waste toner conveyance unit.

Next, the first operation in the third embodiment will be described.

The controller 100 causes the drive motor 478 to rotate the first member 476 in the first direction in a state where the first member 476 and the second member 477 are engaged with each other. Thus, the controller 100 causes the first member 476 to transmit, to the second member 477, a driving force greater than the rotational load of the second member 477 and causes the second member 477 to rotate in the first direction, thereby rotating the brush roller 471 in the first direction.

The brush gear 473 transmits a rotational driving force to the waste toner conveyance gear 475 when the brush roller 471 is rotated by the rotational driving force output from the drive motor 478.

The waste toner conveyance gear 475 transmits, to a waste toner conveyance member, a rotational driving force for rotationally driving the waste toner conveyance member. The waste toner conveyance member conveys waste toner by being rotationally driven.

Next, the second operation in the third embodiment will be described.

The controller 100 causes the drive motor 478 to rotate the first member 476 in the second direction. At this time, the second member 477 and the brush roller 471 are restricted by the one-way clutch 474 so as not to rotate and therefore remain in a stopped state.

The controller 100 rotates the first member 476 in the second direction to cause the first member 476 to collide with the second member 477 and apply an impact force to the second member 477.

The vibration caused by the impact force received by the second member 477 is transmitted to the brush roller 471, the brush gear 473, the waste toner conveyance gear 475, the waste toner conveyance member, the waste toner conveyance route, and the like.

Therefore, as the waste toner conveyance member, the waste toner conveyance route, and the like vibrate, the toner accumulated on the waste toner conveyance member, the waste toner conveyance route, and the like is crushed.

Thus, clogging of the waste toner conveyance route with toner can be prevented. Furthermore, a member for suppressing accumulation of the toner in the waste toner conveyance route is not required.

After the second operation, the controller 100 executes a third operation as an operation of rotating the first member 476 in the first direction at a third operation rotation speed to bring the first member 476 and the second member 477 into the engaged state. In the third operation, the controller 100 stops the third operation after the first member 476 rotates by the third operation angle or more.

Thus, it is possible to reduce the wear at the engagement location between the first member 476 and the second member 477.

### 8. Effect

As described above, the control device according to the present embodiment includes the first member (the drive transmission member 214, the first member 476).

The control device according to the present embodiment includes the second member (the idler gear 211, the second member 477) that is switchable between the engaged state in which the second member is engaged with the first member and the disengaged state in which the second member is not engaged with the first member.

The control device according to the present embodiment includes the controller 100 that executes the first operation and the second operation.

The first operation is the operation of rotating the first member in the engaged state in the first direction.

The second operation is the operation of rotating the first member in a second direction that is a direction opposite to the first direction to alternately switch between the engaged state and the disengaged state, and moving the first member in a direction (X-axis positive direction) that is parallel to the rotation axis of the first member and in which the first member is engaged with the second member when switching from the disengaged state to the engaged state, to thereby apply vibration to the second member.

After the second operation, the controller 100 performs a third operation of rotating the first member in the first direction at a rotational speed lower than the rotational speed during the first operation, to bring the first member and the second member into the engaged state.

Therefore, the engagement portions 214a and 214f and the engaged portions 211a and 211d can be engaged with each other without generating strong impact forces at the abutting locations between the end portions 211b and 211e of the idler gear 211 and the parallel sections 214b and 214g of the drive transmission member 214.

Furthermore, since the first operation can be started from the engaged state of the engagement portions 214a and 214f and the engaged portions 211a and 211d, the wear at the engagement locations of the engagement portions 214a and 214f and the engaged portions 211a and 211d can be reduced.

The first member 476 and the second member 477 can be engaged with each other without generating a strong impact force.

Furthermore, since the first operation can be started from the engaged state of the first member 476 and the second member 477, it is possible to reduce the wear at the engagement location of the first member 476 and the second member 477.

The image forming apparatus 1 according to the present embodiment includes the control device and forms the image on the sheet.

Thus, in the drive transmission member 214 and the idler gear 211 included in the image forming apparatus 1, it is possible to reduce the wear at the engagement locations between the engagement portions 214a and 214f and the engaged portions 211a and 211d.

In the image forming apparatus 1 according to the present embodiment, the first member (drive transmission member 214) includes the engagement portions 214a and 214f disposed at equal intervals.

The second member (idler gear 211) includes the engaged portions 211a and 211d that are equally spaced and engage with the engagement portions 214a and 214f.

The controller 100 stops the third operation after the first member rotates by an angle or more obtained by dividing 360 degrees by the number of sets of the engagement portions 214a and 214f and the engaged portions 211a and 211d in the third operation.

Thus, in the third operation, the engagement portions 214a and 214f and the engaged portions 211a and 211d can be reliably engaged with each other.

The image forming apparatus 1 according to the present embodiment includes a sensing section that senses the engagement of the engagement portions 214a and 214f of the first member (drive transmission member 214) with the engaged portions 211a and 211d, which are to be engaged with the engagement portions 214a and 214f, of the second member (idler gear 211).

The controller 100 stops the third operation when the sensing section senses that the engagement portions 214a and 214f and the engaged portions 211a and 211d are engaged with each other in the third operation.

Thus, in the third operation, the engagement portions 214a and 214f and the engaged portions 211a and 211d can be reliably engaged with each other.

In the image forming apparatus 1 according to the present embodiment, the sensing section senses that the engagement portions 214a and 214f and the engaged portions 211a and 211d are engaged with each other based on a load of the motor (drive motor 212) driving the first member (drive transmission member 214) when the engagement portions 214a and 214f and the engaged portions 211a and 211d are changed from the disengaged state to the engaged state.

Thus, the engagement state of the engagement portions 214a and 214f and the engaged portions 211a and 211d can be easily sensed.

In the image forming apparatus 1 according to the present embodiment, the sensing section senses that the conveyance member (toner conveyance member 202) or the developing roller 204 to which the driving force is transmitted from the first member (drive transmission member 214) rotates, thereby sensing that the engagement portions 214a and 214f and the engaged portions 211a and 211d are engaged with each other.

Thus, the engagement state of the engagement portions 214a and 214f and the engaged portions 211a and 211d can be easily sensed.

In the image forming apparatus 1 according to the present embodiment, the controller 100 performs the second operation and the third operation at the same time as the operation different from the second operation and the third operation performed in the image forming apparatus 1.

Thus, it is not necessary to separately provide time for performing the second operation and the third operation, thereby suppressing a reduction in productivity in the image forming apparatus 1.

The waste toner conveyance unit according to the present embodiment includes a control device, a waste toner conveyance route that conveys the waste toner, a waste toner conveyance member disposed in the waste toner conveyance route, and a drive section (drive motor 478, driver) that drives the first member 476.

In the first operation, the first member 476 transmits the driving force from the drive section to the waste toner conveyance member via the second member 477 in the engaged state with the first member 476.

In the second operation, the first member 476 applies vibration to the waste toner conveyance member and the waste toner conveyance route via the second member 477.

Thus, clogging of the waste toner conveyance route with toner can be prevented. Furthermore, a member for suppressing accumulation of the toner in the waste toner conveyance route is not required.

Although specific description has been given above based on the embodiment according to the present disclosure, the detailed configuration of each device constituting the image forming apparatus 1 and the detailed operation of each device can also be appropriately changed without departing from the scope of the present disclosure.

For example, although the developing device 412 is a two-component developing method in the embodiment described above, the developing device 412 may be a one-component developing method.

In the above description, an example in which an HDD, a semiconductor nonvolatile memory, or the like is used as a computer-readable medium of the program according to the present disclosure has been disclosed, but the present disclosure is not limited to this example. As other computer-readable media, portable recording media such as CD-ROMs can be applied. Furthermore, a carrier wave is also applied as a medium for providing data of the program according to the present disclosure via a communication line.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. A control device comprising:
a first member;
a second member that is configured to be capable of switching between an engaged state in which the second member is engaged with the first member and a disengaged state in which the second member is not engaged with the first member; and
a hardware processor that executes, a first operation in which the first member in the engaged state is rotated in a first direction, and a second operation in which the first member is rotated in a second direction opposite to the first direction to alternately switch between the engaged state and the disengaged state, and when switching from the disengaged state to the engaged state, the first member is moved in a direction that is parallel to a rotation axis of the first member to be engaged with the second member, thereby vibrating the second member,
wherein the hardware processor performs, after the second operation, a third operation of rotating the first member in the first direction at a rotational speed slower than the rotational speed during the first operation, and the first member and the second member are engaged to the engaged state.

2. An image forming apparatus comprising:
the control device according to claim 1,
wherein the image forming apparatus forms an image on a sheet.

3. The image forming apparatus according to claim 2, wherein,
the first member includes engagement portions that are arranged at equal intervals, and
the second member includes engaged portions that are arranged at equal intervals and that engage with the engagement portions.

4. The image forming apparatus according to claim 3, wherein the hardware processor stops the third operation after the first member rotates by an angle or more in the third operation, the angle being obtained by dividing 360 degrees by a number of sets of the engagement portion and the engaged portion.

5. The image forming apparatus according to claim 2,
further comprising a sensing section that senses an engagement of an engagement portion of the first member and an engaged portion of the second member to be engaged with the engagement portion,
wherein the hardware processor stops the third operation in a case in which the sensing section senses that the engagement portion and the engaged portion are engaged with each other in the third operation.

6. The image forming apparatus according to claim 5, wherein the sensing section senses that the engagement portion and the engaged portion are engaged with each other based on a load of a motor that drives the first member when the engagement portion and the engaged portion are changed from the disengaged state to the engaged state.

7. The image forming apparatus according to claim 5, wherein the sensing section senses that the engagement portion and the engaged portion are engaged with each other by sensing that a conveyance member or a developing roller to which a driving force is transmitted from the first member rotates.

8. The image forming apparatus according to claim 2, wherein the controller performs the second operation and the third operation at the same time as an operation different from the second operation and the third operation performed in the image forming apparatus.

9. A waste toner conveyance unit comprising:
the control device according to claim 1;
a waste toner conveyance route that conveys waste toner;
a waste toner conveyor disposed in the waste toner conveyance route; and
a driver that drives the first member,
wherein the first member,
in the first operation, transmits a driving force from the driver to the waste toner conveyor via the second member in the engaged state with the first member, and
in the second operation, applies vibration to the waste toner conveyor and the waste toner conveyance route via the second member.

10. A non-transitory computer readable storage medium comprising a program executed in a computer provided with a control apparatus including, a first member; and a second member that is configured to be capable of switching between an engaged state in which the second member is engaged with the first member and a disengaged state in which the second member is not engaged with the first member, to function as a controller that executes,
a first operation in which the first member in the engaged state is rotated in a first direction, and a second operation in which the first member is rotated in a second direction opposite to the first direction to alternately switch between the engaged state and the disengaged state, and when switching from the disengaged state to the engaged state, the first member is moved in a direction that is parallel to a rotation axis of the first member to be engaged with the second member, thereby vibrating the second member,
wherein the controller performs, after the second operation, a third operation of rotating the first member in the first direction at a rotational speed slower than the rotational speed during the first operation, and the first member and the second member are engaged to the engaged state.
